(19) United States
(12) Patent Application Publication
(10) Pub. No.: US 2025/0332529 A1
(43) Pub. Date: Oct. 30, 2025

(54) MINERAL CARTRIDGE STICK

(71) Applicant: SHILIN HUANG, CHENZHOU (CN)

(72) Inventor: SHILIN HUANG, CHENZHOU (CN)

(21) Appl. No.: 18/668,195

(22) Filed: May 19, 2024

(30) Foreign Application Priority Data
Apr. 29, 2024 (CN) 202420932774.7

(51) Int. Cl. B01D 27/08; B01D 35/30

(52) U.S. Cl. CPC B01D 27/08; B01D 35/306; B01D 2201/4084

(57) ABSTRACT

A mineral cartridge stick includes a filter element and at least two connecting components. The filter element defines through holes and an accommodating space for accommodating filtering materials. The through holes are communicated with the accommodating space. The filter element includes a connecting head. Each of the connecting components includes a connecting body, a first connecting end, and a second connecting end. The first connecting end thereof is connected to a first end of the connecting body thereof, and the second connecting end thereof is connected to a second end of the connecting body thereof. The first connecting end of a first connecting component is detachably connected to the connecting head. The first connecting end of a second connecting component is detachably connected to the second connecting end of the first connecting component.

### TECHNICAL FIELD

The present disclosure relates to a field of water purification technology, and in particular to a mineral cartridge stick.

### BACKGROUND

In the prior art, a water purification system commonly includes a filter element device. The filter element device includes a filter element stick and a filter element holder. The filter element stick is installed in the filter element holder. The filter element holder is connected to a water inlet pipe and a water outlet pipe. Water enters the water inlet pipe and flows to the filter element holder through the filter element stick. After the filter element stick filters the water, the filtered water enters the water outlet pipe.

However, for different application scenarios, the filter element stick and the filter element holder with a fixed size and structure can no longer meet needs of users in different application scenarios.

### SUMMARY

The present disclosure provides a mineral cartridge stick. The mineral cartridge stick includes a filter element and at least two connecting components. A specific number of the at least two connecting components is determined according to user needs to meet user needs.

In a first aspect, the present disclosure provides a mineral cartridge stick including a filter element and at least two connecting components.

The filter element defines through holes and an accommodating space for accommodating filtering materials. The through holes are communicated with the accommodating space. The filter element includes a connecting head.

Each of the connecting components includes a connecting body, a first connecting end, and a second connecting end. The first connecting end thereof is connected to a first end of the connecting body thereof, and the second connecting end thereof is connected to a second end of the connecting body thereof. The at least two connecting components include a first connecting component and a second connecting component. The first connecting end of the first connecting component is detachably connected to the connecting head. The first connecting end of the second connecting component is detachably connected to the second connecting end of the first connecting component.

In one optional embodiment, the first connecting end of the first connecting component is sleeved with the connecting head, or the first connecting end of the first connecting component is screwed with the connecting head, or the first connecting end of the first connecting component snapped with the connecting head, or the first connecting end of the first connecting component is detachably connected to the connecting head through a first detachable component.

In one optional embodiment, the first connecting end of the second connecting component is sleeved with the second connecting end of the first connecting component, or the first connecting end of the second connecting component is screwed with the second connecting end of the first connecting component, or the first connecting end of the second connecting component is snapped with the second connecting end of the first connecting component, or the first connecting end of the second connecting component is detachably connected to the second connecting end of the first connecting component through a scone detachable component.

In one optional embodiment, a length of the first connecting component is equal to a length of the second connecting component, or the length of the first connecting component is greater than the length of the second connecting component, or the length of the first connecting component is less than the length of the second connecting component.

In one optional embodiment, the first connecting end of the second connecting component is sleeved in the second connecting end of the first connecting component. A protrusion is disposed on an outer surface of each second connecting end. A clamping hole is defined on each first connecting end. Each protrusion is allowed to be clamped in a corresponding clamping hole and is allowed to be taken out of the corresponding clamping hole.

In one optional embodiment, a sliding groove is defined on each first connecting end and is communicated with a corresponding clamping hole. Each sliding groove is located on an inner surface of each first connecting end. Each protrusion is slidable in a corresponding sliding groove. The protrusion of the first connecting component is clamped in the clamping hole of the second connecting component through the sliding groove of the second connecting component.

In one optional embodiment, reinforcing ribs are connected between the second connecting end of each of the connecting components and the connecting body thereof. The reinforcing ribs of each of the connecting components are spaced apart from the protrusion thereof.

In one optional embodiment, a thickness of each of the reinforcing ribs gradually increases from a first end thereof away from a corresponding connecting body to a second end thereof connected to the corresponding connecting body.

In one optional embodiment, protruding rings spaced apart from each other are disposed on an outer surface of each connecting body. The protruding rings thereof are disposed around the outer surface of each connecting body.

In one optional embodiment, a size of each of the protruding rings gradually increases from a first end of each of the protruding rings away from each connecting body to a second end of each of the protruding rings connected with each connecting body.

In one optional embodiment, a cross-section of each of the protruding rings is arc-shaped.

In one optional embodiment, two first protruding structures and two second protruding structures are disposed on the outer surface of each connecting body. The two first protruding structures of each of the connecting components are close to the first connecting end thereof. The two first protruding structures of each of the connecting components are disposed opposite to each other, the two second protruding structures of each of the connecting components are close to the second connecting end of each of the connecting components, and the two second protruding structures of each of the connecting components are disposed opposite to each other.

In one optional embodiment, a length of each of the first protruding structures is greater than a length of each of the second protruding structures along a length direction of the mineral cartridge stick.

In one optional embodiment, the mineral cartridge stick includes a filter element housing and a filter element cover. The filter element housing is detachably connected to the filter element cover. The connecting head is disposed on the filter element cover. The through holes are defined on the filter element housing. The accommodating space is defined in the filter element housing.

In one optional embodiment, a first end of the filter element housing defines an opening. The opening is communicated with the accommodating space. When the filter element cover is connected to the filter element housing, the filter element cover covers the opening.

In one optional embodiment, the filter element cover further includes a cover body. The connecting head is connected to the cover body. At least a part of the cover body is inserted into the accommodating space from the opening to cover the opening. The connecting head extends outside the filter element housing from the one end of the filter element housing.

In one optional embodiment, the filter element housing is snapped with the filter element cover. At least one first limiting structure is disposed on an inner surface of the filter element housing. At least one second limiting structure is disposed on an edge of an outer surface of the cover body. The at least one first limiting structure is connected to the at least one second limiting structure to connect the filter element cover to the filter element housing, and the at least one first limiting structure is separated from the at least one second limiting structure to separate the filter element cover from the filter element housing.

In a second aspect, the present disclosure provides a mineral cartridge stick including at least two connecting components.

Each of the connecting components includes a connecting body, a first connecting end and a second connecting end. The first connecting end thereof is connected to a first end of the connecting body thereof, and the second connecting end thereof is connected to a second end of the connecting body thereof. The first connecting end of one of the connecting components is detachably connected to the second connecting end of the other one of the connecting components.

In the embodiments of the present disclosure, the at least two connecting components are detachably connected to the filter element, and the at least two connecting components are detachably connected to each other, so that different numbers of connecting components are selected according to different needs, or the connecting components of different sizes are selected to meet needs of different scenarios.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a front side elevational schematic diagram of a mineral cartridge stick according to a first embodiment of the present disclosure.

FIG. 2 is a cross-sectional schematic diagram of the mineral cartridge stick taken along the line A-A shown in FIG. 1.

FIG. 3 is a perspective schematic diagram of the mineral cartridge stick according to the first embodiment of the present disclosure.

FIG. 4 is an exploded schematic diagram of the mineral cartridge stick according to the first embodiment of the present disclosure.

FIG. 5 is an enlarged schematic diagram of portion A shown in FIG. 2.

FIG. 6 is an enlarged schematic diagram of portion B shown in FIG. 2.

FIG. 7 is an enlarged schematic diagram of portion C shown in FIG. 2.

FIG. 8 is a schematic diagram of two connecting components of the mineral cartridge stick according to the first embodiment of the present disclosure.

FIG. 9 is a perspective schematic diagram of a first connecting component of the mineral cartridge stick according to the first embodiment of the present disclosure.

FIG. 10 is an enlarged schematic diagram of portion D shown in FIG. 9.

FIG. 11 is a perspective schematic diagram of a filter element of the mineral cartridge stick according to the first embodiment of the present disclosure.

FIG. 12 is a perspective schematic diagram of a filter element housing of the mineral cartridge stick according to the first embodiment of the present disclosure.

FIG. 13 is a perspective schematic diagram of a filter element cover of the mineral cartridge stick according to the first embodiment of the present disclosure.

FIG. 14 is an exploded schematic diagram of the mineral cartridge stick according to a second embodiment of the present disclosure.

FIG. 15 is an exploded schematic diagram of the mineral cartridge stick according to a third embodiment of the present disclosure.

### DETAILED DESCRIPTION

In current commercial field, based on manufacturing costs and different user requirements, a length of a container configured to hold filter materials is restricted to varying degrees. Therefore, an extension rod is connected to the container. The extension rod has a function of extending and supporting the container, thus expanding a function of the container.

It is noted that the extension rod may have different lengths, and a length of the extension rod itself also limits an overall length of the container after the extension rod is connected. In the embodiments of the present disclosure, the extended rod is defined as a basic length rod.

In actual production and life, producing and storing basic length rods results in a certain degree of waste of resources. For example, manufacturers and sellers need to produce and store the basic length rods according to different user needs. In a current market, there are products produced by different manufacturers that provide same functions, resulting in overcapacity and waste of earth resources. For another example, the basic length rods are made of plastic, and improper process of the plastic is harmful to the earth's ecology.

On this premise, the inventor designed the basic length rods to enable that any two basic length rods are connected to each other to meet a length requirement of the container. Therefore, an actual length requirement of the container is met by connecting different numbers of base length rods. Reflecting in real life, different needs of the users for the length of the container in different scenarios are efficiently solved, which further improves resource utilization.

Illustratively, embodiments of the present disclosure provide a mineral carriage stick including at least two connecting components. Structures disposed on two ends of each of the connecting components enables any two of the at least two connecting components being sleeved with each other. It should be noted that the connecting components in the embodiments of the present disclosure are also known as rods. A length of each of the connecting components is not limited and are determined according to actual needs. For example, each of the connecting components includes the connecting structures disposed on the two ends thereof, and any two of the at least two connecting component are connected (i.e. sleeved with each other) through the connecting structures disposed on two ends of each of the connecting components. In order to clearly illustrate inventive concept of the embodiments of the present disclosure, an exemplary description is given below with reference to the exemplary drawings.

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. The following description of at least one exemplary embodiment is merely illustrative and is in no way intended as any limitation on the present disclosure, applications thereof, and use thereof. Based on the embodiments of the present disclosure, all other embodiments obtained by those of ordinary skill in the art without creative work shall fall within the protection scope of the present disclosure.

Reference herein to “embodiment” or “implement” means that a particular feature, structure, or characteristic described in connecting with one embodiment or one implement may be included in at least one embodiment of the present disclosure. The appearances of the “embodiment” in various positions in the specification are not necessarily referring to the same embodiment, and are not independent or alternative embodiments mutually exclusive of other embodiments. Those skilled in the art explicitly and implicitly understand that the embodiments described herein may be combined with other embodiments.

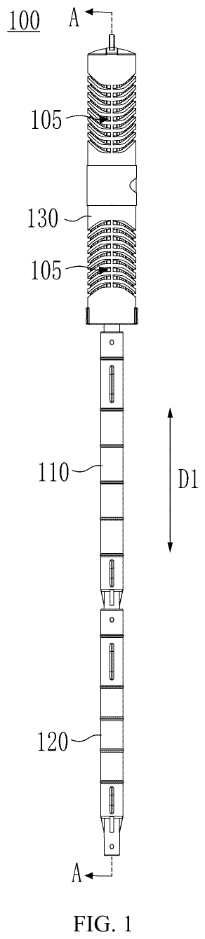

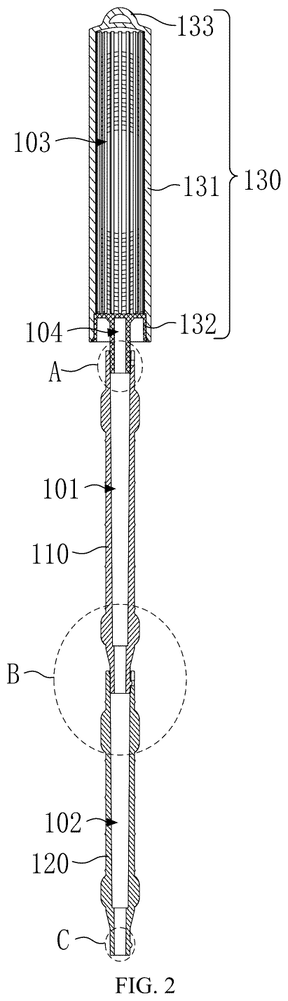

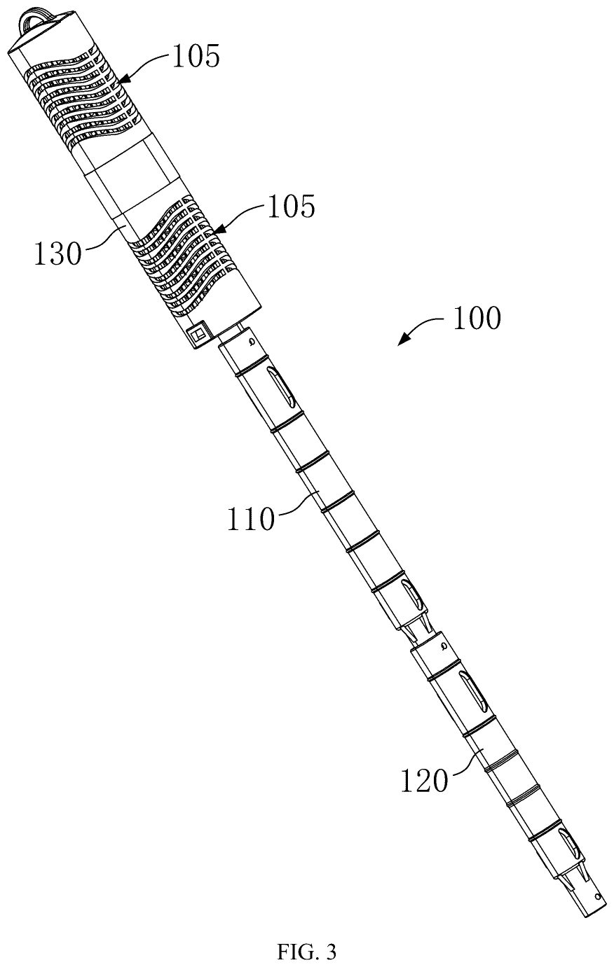

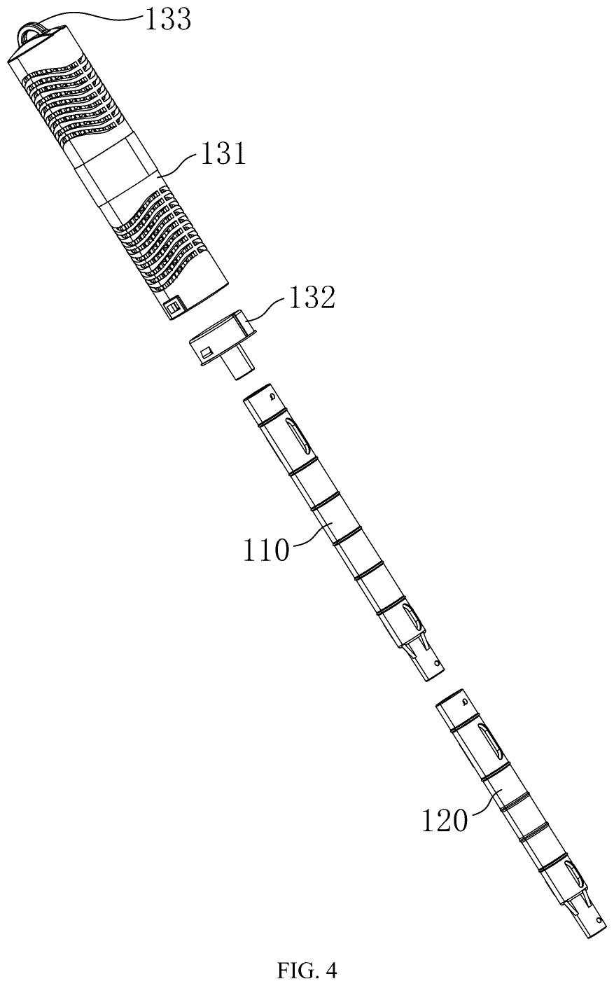

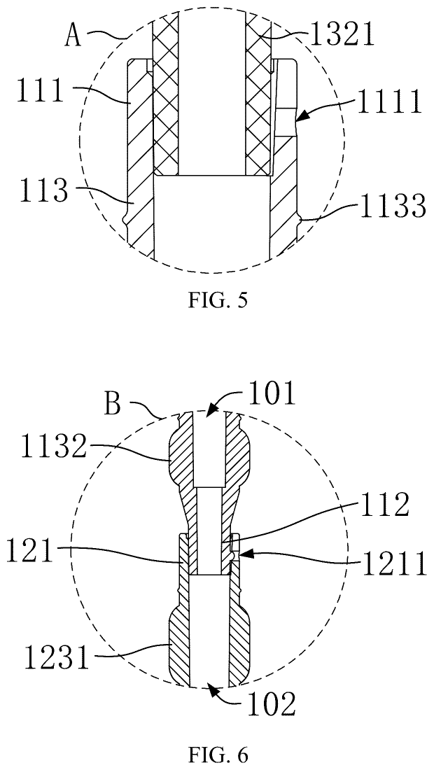

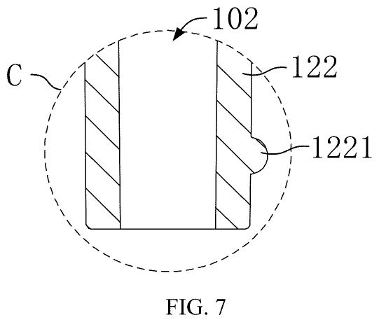

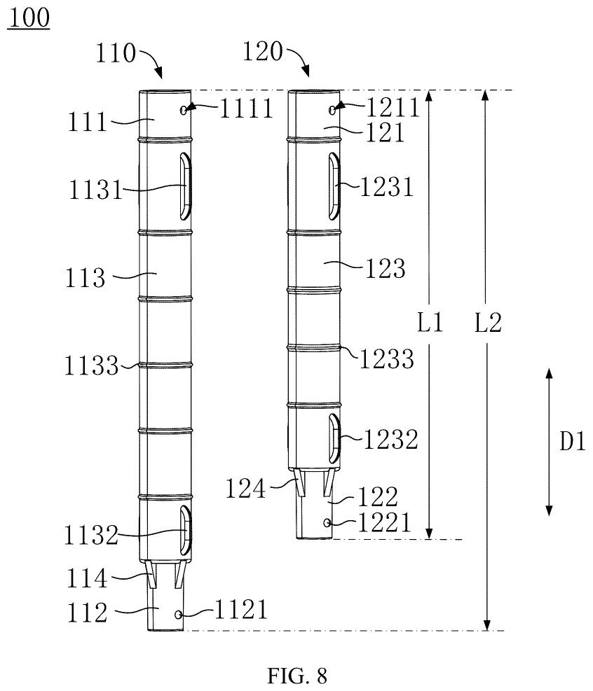

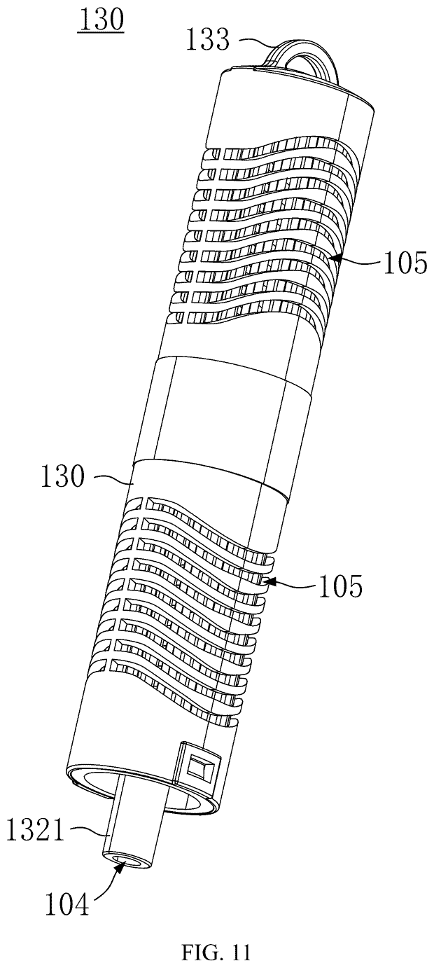

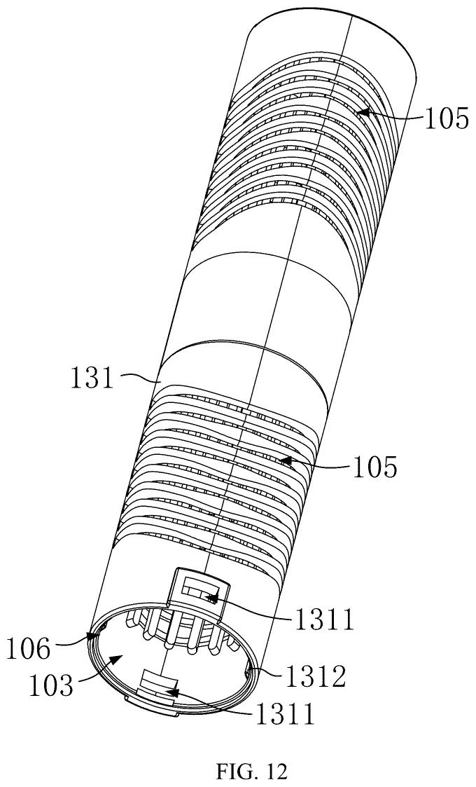

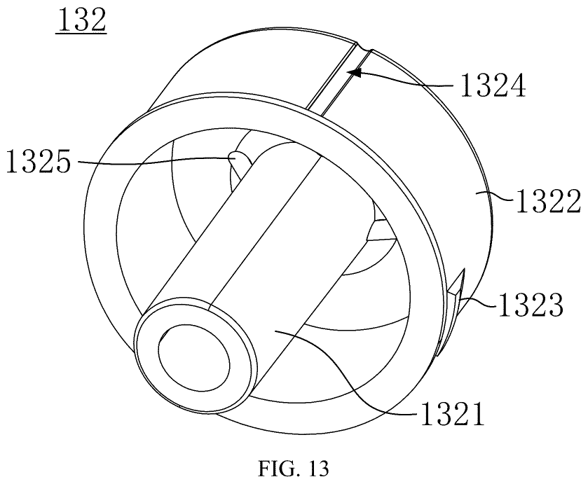

As shown in FIG. 1 to FIG. 13, a first embodiment of the present disclosure provides a mineral carriage stick 100. The mineral carriage stick 100 includes a filter element 130 and at least two connecting components. The at least two connecting components in the first embodiment of the present disclosure may include two connecting components, three connecting components, four connecting components, etc., which are not limited thereto. The first embodiment of the present disclosure take an example in which the at least two connecting components include two connecting components for description. Specifically, the at least two connecting components include a first connecting component 110 and a second connecting component 120.

The mineral carriage tick 100 defines a length direction D1. It should be understood that the length direction D1 of the mineral carriage tick 100 is same as a length direction of the filter element 130, and the length direction D1 of the mineral carriage tick 100 is same as a length direction of any one of the at least two connecting components.

As shown in FIGS. 1-4 and 11-13, the filter element 130 defines through holes 105 and at least one accommodating space 103 for accommodating filtering materials. The through holes 105 are communicated with the at least one accommodating space 103. Specifically, there may be one accommodating space 103 or there may be a plurality of accommodating spaces 103, the present disclosure hereby takes an example that one accommodating space 103 is provided for further illustration.

When in actual use, water to be filtered enters the accommodating space 103 from one or more first through holes of the through holes 105, are filtered by the filtering materials accommodated in the accommodating space 103, and flows out from one or more second through holes of the through holes 105, so that the water is filtered. The filtering materials are also called filters. The filtering materials are mineral materials, such as mineral stones. It should be understood that the mineral stones are accommodated in the accommodating space 103 and are unable to separate from the accommodating space 103 from the through holes 105. The one or more first through holes 105 through which the water to be filtered flows are different from the one or more second through holes 105 through which the water filtered by the filtering materials flows out.

Specifically, the filter element 130 includes a filter element housing 131 and a filter element cover 132. The filter element housing 131 is connected to the filter element cover 132. For example, the filter element housing 131 and the filter element cover 132 are detachably connected. Namely, the filter element housing 131 and the filter element cover 132 are allowed to be connected together and are also allowed to be separated from each other. Specifically, the filter element housing 131 is snapped with the filter element cover 132. The filter element housing 131 includes snapping holes 1311, the filter element cover 132 includes buckles 1323, the buckles 1323 are allowed to be snapped in the snapping holes 1311, and the buckles 1323 are also allowed to be released from the snapping holes 1311. The number of the buckles 1323 is equal to the number of the snapping holes 1311. For example, there are two buckles 1323 and two snapping holes 1311, and it should be understood that the number of the buckles 1323 and the number of the clamping holes 1311 are not limited to two, and may also be other numbers, such as three, which are not further illustrated herein.

It should be understood that the filter element housing 131 and the filter element cover 132 are detachably connected to facilitate replacement of the filtering materials.

A first end of the filter element housing 131 defines an opening 106. The opening 106 is communicated with the accommodating space 103, and the filtering materials are filled in the accommodating space 103 from the opening 106. When the filter element cover 132 is connected to the filter element housing 131, the filter element cover 132 covers the opening 106, so that the filtering materials are limited in the accommodating space 103 by the filter element cover 132. In the embodiment of the present disclosure, the filter element cover 132 is referred to as a plug, that is, the filtering materials disposed in the accommodating space 103 are blocked by the plug.

The through holes 105 are defined on the filter element housing 131. Specifically, the through holes 105 are spaced apart on a peripheral side of the filter element housing 131, so that the water to be filtered is allowed to flow into the accommodating space 103 from the through holes 105, and the water filtered in the accommodating space 103 is allowed to flow out of the through holes 105 to an outside. Specifically, the through holes 105 circumferentially surround the filter element housing 131.

For example, the filter element cover 132 includes a cover body 1322 and a connecting head 1321. The connecting head 1321 is connected to the cover body 1322. Specifically, the connecting head 1321 and the cover body 1322 are integrally disposed. At least a part of the cover body 1322 is inserted into the accommodating space 103 from the opening 106 to cover the opening 106, and the connecting head 1321 extends outside the filter element housing from a first end of the filter element housing 131, which facilitates the connecting head 1321 to be connected to one of the connecting components. The connecting head 1321 in the embodiment of the present disclosure is configured to detachably connect to one of the at least two connecting components. In order to increase connection stability between the connecting head 1321 and the cover body 1322, especially to increase stability of the connecting head 1321, reinforcing structures 1325 are connected between the connecting head 1321 and the cover body 1322.

In order to increase the connection stability between the filter element cover 132 and the filter element housing 131, at least one first limiting structure 1312 is disposed on an inner surface of the filter element housing 131, at least one second limiting structure 1324 is defined on an outer surface of an edge of the cover body 1322 of the filter element cover 132, and the at least one first limiting structure 1312 is connected to the at least one second limiting structure 1324 to connect the filter element cover 132 to the filter element housing 131. For example, the at least one first limiting structure 1312 is a limiting bar, the at least one second limiting structure 1324 is a limiting groove, and the limiting bar is installed in the limiting groove to connect the filter element cover 132 to the filter element housing 131. It should be noted that the at least one first limiting structure 1312 and the at least one second limiting structure 1324 may be connected in other ways, which is not limited by installing the first limiting structure 1312 in the at least one second limiting structure 1324.

Specifically, the filter element 130 further includes a handle 133, and the handle 133 is disposed on a second end of the filter element housing 131. In other words, the handle 133 is disposed on one end of the filter element housing 131 away from the at least two connecting components, and the handle 133 is disposed on the one end of the filter element housing 131 away from the filter element cover 132. It should be understood that the handle 133 is configured for being held by a user. It should be noted that the handle 133 is also served as a hook for hanging the mineral carriage stick 100. It should also be noted that the handle 133 is further configured to connect to other components such as connecting to a rope by binding.

Furthermore, the filter cartridge cover 132 defines a groove 104, and an opening of the groove 104 is away from the filter element housing 131. The groove 104 is defined on the connecting head 1321. For instance, the groove 104 is defined on a center of the connecting head 1321, and the groove 104 do not contact a bottom portion of the cover body 1322. That is, the groove 104 ends in the cover body 1322, so that the cover body 1322 is able to block the opening 106. In practical application, the mineral carriage stick 100 is placed in a bathtub, a swimming pool, etc. A water circulation device of the bathtub, the swimming pool, etc., has a water circulation function. For example, a water pump of the water circulation device drives the water to flow, the water flows into the accommodating space 103 of the mineral carriage stick 100 from one or more of the first through holes of the through holes 105 in a water flowing process, and the water is filtered by the filtering materials in the accommodating space 103, then the filtered water flows out of the one or more second through holes of the through holes 105.

In the embodiment, since the groove 104 is defined on the connecting head 1321, the connecting head 1321 is hollow. In other words, the connecting head 1321 defines a channel penetrating the connecting head 1321 along the length direction D1 of the mineral carriage stick 100. In the embodiment of the present disclosure, the length direction D1 of the mineral carriage stick 100 is also the length direction of the connecting head 1321.

In other optional embodiments, the groove 104 may also penetrate the cover body 1322 to form a through-hole structure to communicate with the accommodating space 103. It should be understood that when the groove 104 penetrates the cover body 1322 and is communicated with the accommodating space 103, a pore size of the groove 104 is less than a size of any one of the filtering materials to limit the filtering materials in the accommodating space 103.

As shown in FIGS. 1-10, each of the connecting components includes a connecting body, a first connecting end, and a second connecting end. The first connecting end thereof is connected to a first end of the connecting body thereof, and the second connecting end thereof is connected to a second end of the connecting body thereof. The first connecting end of one of the at least one connecting components is detachably connected to the connecting head. The first connecting end of the other one of the connecting components is detachably connected to the second connecting end of the one of the at least two connecting components. Specifically, the first connecting component 110 has the connecting body 113, the first connecting end 111, and second connecting end 112. The first connecting end 111 and the second connecting end 112 are respectively connected to two ends of the connecting body 113. The second connecting component 120 has the connecting body 123, the first connecting end 121, and second connecting end 122. The first connecting end 121 and the second connecting end 122 are respectively connected to two ends of the connecting body 123. In the embodiment of the present disclosure, the word “have” is understood as “include”.

Specifically, each of the connecting components includes a channel sequentially penetrating through the first connecting end thereof, the connecting body thereof, and the second connecting end thereof. In a case that the first connecting end of the first connecting component 110 is connected to the connecting head, the channel thereof is communicated with the groove 104. In the embodiment, the first connecting component 110 includes a channel 101 sequentially penetrating through the first connecting end 111, the connecting body 113, and the second connecting end 112. The second connecting component 120 includes a channel 102 sequentially penetrating through the first connecting end 121, the connecting body 123, and the second connecting end 122. When the groove 104 is communicated with the accommodating space 105, the channel 101 and/or the channel 102 are communicated with the accommodating space 105 through the groove 104. In the embodiment of the present disclosure, each of the connecting components defining the channel thereof is understood as a hollow connecting component. That is, the first connecting component 110 is hollow, and the second connecting component 120 is hollow. In other words, each of the connecting components defines the channel along the length direction thereof.

The first connecting end 111 of the first connecting component 110 and the first connecting end 121 of the second connecting component 120 are alternatively detachably connected to the connecting head 1321. The present disclosure takes an example that the first connecting end 111 of the first connecting component 110 is connected to the connecting head 1321 for illustration. It should be understood that the first connecting end 121 of the second connecting component 120 may also be detachably connected to the connecting head 1321. Specifically, the first connecting end 111 of the first connecting component 110 is sleeved with the connecting head, or the first connecting end of the first connecting component is screwed with the connecting head, or the first connecting end of the first connecting component snapped with the connecting head, or the first connecting end of the first connecting component is detachably connected to the connecting head through a first detachable component.

For example, the first connecting end 111 of the first connecting component 110 and the connecting head 1321 are sleeved with each other. Specifically, the first connecting end 111 of the first connecting component 110 is allowed to be sleeved on the connecting head 1321, and the first connecting end 111 of the first connecting component 110 is allowed to be separated from the connecting head 1321. In other optional embodiments, the connecting head 1321 is allowed to be sleeved on the first connecting end 111 of the first connecting component 110, and the connecting head 1321 is also allowed to be separated from the first connecting end 111 of the first connecting component 110. It should be noted that the two connecting components connected to each other are communicated with each other through a respective channel.

When the first connecting end 111 of the first connecting component 110 is sleeved on the connecting head 1321, i.e., the first connecting end 111 of the first connecting component 110 is communicated with the connecting head 1321, the channel 101 of the first connecting component 110 is communicated with the groove 104. It is understood that the connecting head 1321 is hollow, and the first connecting component 110 and the second connecting component 120 are hollow, so that the first connecting component 110 and/or the second connecting component is connected to the connecting head 1321.

Furthermore, when the first connecting end 111 of the first connecting component 110 is sleeved on the connecting head 1321, the connecting head 1321 is connected to the first connecting end 111 of the first connecting component 110 by an interference fit, so as to realize a tight connection between the first connecting end 111 of the first connecting component 110 and the connecting head 1321.

The second connecting end 112 of the first connecting component 110 is detachably connected to the first connecting end 121 of the second connecting component 120. That is, the second connecting end 112 of the first connecting component 110 is allowed to be connected to or separated from the first connecting end 121 of the second connecting component 120. Specifically, the first connecting end 121 of the second connecting component 120 is sleeved with the second connecting end 112 of the first connecting component 110; or the first connecting end 121 of the second connecting component 120 is screwed with the second connecting end 112 of the first connecting component 110; or the first connecting end 121 of the second connecting component 120 is snapped with the second connecting end 112 of the first connecting component 110; or the first connecting end 121 of the second connecting component 120 is detachably connected to the second connecting end 112 of the first connecting component 110 through a scone detachable component.

For example, the first connecting end 121 of the second connecting component 120 is sleeved with the second connecting end 112 of the first connecting component 110. Specifically, the first connecting end 121 of the second connecting component 120 is allowed to be sleeved on the second connecting end 112 of the first connecting component 110, and the first connecting end 121 of the second connecting component 120 is allowed to be separated from the second connecting end 112 of the first connecting component 110. In other optional embodiments, the second connecting end 112 of the first connecting component 110 is allowed to be sleeved on the first connecting end 121 of the second connecting component 120, and the second connecting end 112 of the first connecting component 110 is allowed to be separated from the first connecting end 121 of the second connecting component 120.

When the first connecting end 121 of the second connecting component 120 is sleeved on the second connecting end 112 of the first connecting component 110, i.e., the first connecting end 121 of the second connecting component 120 is connected to the second connecting end 112 of the first connecting component 110, the channel 101 of the first connecting component 110 is communicated with the channel 102 of the second connecting component 120.

In order to increase connection stability between the second connecting component 120 and the first connecting component 110, the second connecting component 120 and the first connecting component 110 in the embodiment of the present disclosure are connected to each other by a clamping structure. A protrusion 1121 is disposed on an outer surface of the second connecting end 112 of the first connecting component 110, and a protrusion 1221 is disposed on an outer surface of the second connecting end 122 of the second connecting component 120. The first connecting end 111 of the first connecting component 110 defines a clamping hole 1111, and the first connecting end 121 of the second connecting part 120 defines a clamping hole 1211. The protrusion 1121 is allowed to be installed in the clamping hole 1211 and the protrusion 1121 is allowed to be separated from the clamping hole 1211. The protrusion 1221 is allowed to be installed in the clamping hole 1111 and the protrusion 1221 is allowed to be separated from the clamping hole 1111.

For example, when the first connecting end 121 of the second connecting component 120 is sleeved on the second connecting end 112 of the first connecting component 110, the protrusion 1121 is installed in the clamping hole 1211. When the first connecting end 111 of the first connecting component 110 is sleeved on the second connecting end 122 of the second connecting component 120, the protrusion 1221 is installed in the clamping hole 1111.

It should be noted that a clamping manner between the second connecting component 120 and the first connecting component 110 is not limited thereto. For example, each clamping hole is in an L shape, that is, each clamping hole is divided into two sections, and the second connecting component 120 and the first connecting component 110 rotate relative to each other to realize that the corresponding protrusion is installed in a second section of a corresponding clamping hole from a first section of the corresponding clamping hole. It should be understood that the second connecting component 120 and the first connecting component 110 may be connected by other clamping structure.

It should be noted that a method of enhancing the connection stability between the first connecting component 110 and the second connecting component 120 is not limited thereto. In other optional embodiments, when the first connecting end 121 of the second connecting component 120 is sleeved on the second connecting end 112 of the first connecting component 110, the first connecting end 121 of the second connecting component 120 is in interference fit with the second connecting end 112 of the first connecting component 110, so as to realize a tight connection between the first connecting end 121 of the second connecting component 120 and the second connecting end 112 of the first connecting component 110.

In other optional embodiments, when the first connecting end 121 of the second connecting component 120 is sleeved on the second connecting end 112 of the first connecting component 110, a restricting structure or a positioning structure may also be used to increase the connection stability between the second connecting component 120 and the first connecting component 110. For example, the second connecting component 120 is positioned and limited with respect to the first connecting component 11 by installing a protruding structure thereof in a recess thereof or by installing a positioning strip in a positioning groove thereof.

In other optional embodiments, the first connecting component 110 is screwed with the second connecting component 120. Specifically, internal threads are disposed on an inner surface of the first connecting end 111 of the first connecting component 110, outer threads are disposed on an outer surface of the second connecting end 122 of the second connecting component 120, and the outer threads of the second connecting component 120 are allowed to be screwed with or separated from the internal threads of the first connecting component 110.

In other optional embodiments, when the first connecting component 110 and the second connecting component 120 are detachably connected through the second detachable component, the second detachable component is sleeved on the first connecting component 110 and the second connecting component 120, and the second detachable component is detachably screwed with the first connecting component 110 and the second connecting component 120.

It should be noted that, when the first connecting end 111 of the first connecting component 110 or the first connecting end 121 of the second connecting component 120 is connected to the connecting head 1321 in other connecting manners, the connection manners thereof may be referred to connecting manners between the first connecting component 110 and the second connecting component 120 mentioned above, and details are not repeatedly described herein.

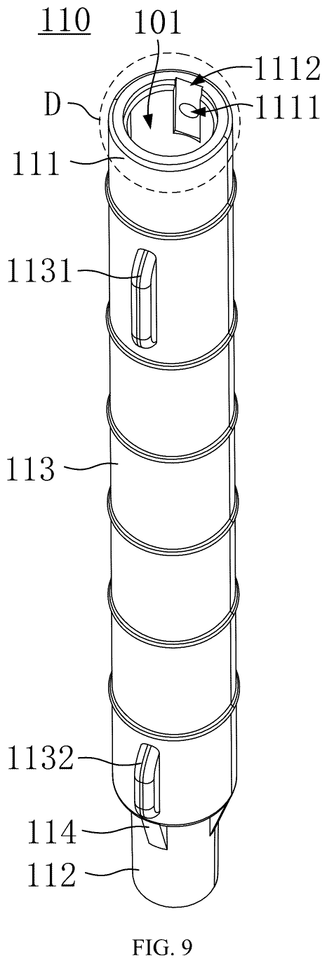

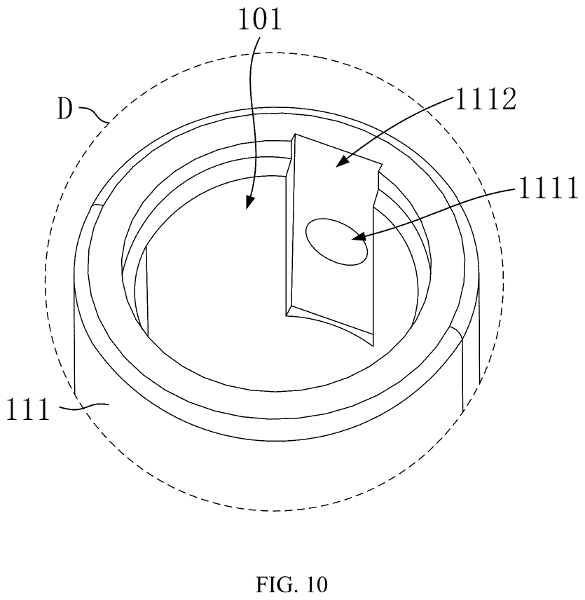

Furthermore, as shown in FIGS. 9 and 10, a sliding groove 1112 communicated with the clamping hole 1111 is defined on the first connecting end 111 of the first connecting component 110. The sliding groove 1112 of the first connecting component 110 is located on the inner surface of the first connecting end 111 of the first connecting component 110. The protrusion 1221 of the second connecting component 120 is slidable in the sliding groove 1112 of the first connecting component 110, and the protrusion 1221 of the second connecting component 120 is installed in the clamping hole 1111 of the first connecting component 110 after sliding through the sliding groove 1112 of the first connecting component 110. It should be noted that a sliding groove communicated with the clamping hole 1211 is defined on the first connecting end 121 of the second connecting component 120, and a structure of the sliding groove of the second connecting component 120 is same as a structure of the sliding groove 1112 of the first connecting component 110, which is not repeatedly described herein.

As shown in FIGS. 1-9, reinforcing ribs 114 are connected between the second connecting end 112 of the first connecting component 110 and the connecting body 113, and the reinforcing ribs 114 are spaced apart from the protrusion 1121 of the first connecting component 110. Specifically, the reinforcing ribs 114 are disposed at equal intervals around a periphery of the second connecting end 112 of the first connecting component 110. Reinforcing ribs 124 are connected between the second connecting end 122 of the second connecting component 120 and the connecting body 123, and the reinforcing ribs 124 of the second connecting component 120 are spaced apart from the protrusion 1221 of the second connecting component 120. Specifically, the reinforcing ribs 124 of the second connecting component 120 are disposed at equal intervals around a periphery of the second connecting end 122 of the second connecting component 120.

Furthermore, a thickness of each of the reinforcing ribs 114 gradually increases from a first end thereof away from the connecting body 113 of the first connecting component 110 to a second end thereof connected to the connecting body 113 of the first connecting component 110. A thickness of each of the reinforcing ribs 124 gradually increases from a first end thereof away from the connecting body 123 of the second connecting component 120 to a second end thereof connected to the connecting body 133 of the second connecting component 120.

Furthermore, protruding rings 1133 spaced apart from each other are disposed on an outer surface of the connecting body 113 of the first connecting component 110, and the protruding rings 1133 are disposed around the outer surface of the connecting body 113. Protruding rings 1233 spaced apart from each other are disposed on an outer surface of the connecting body 123 of the second connecting component 120, and the protruding rings 1233 are disposed around the outer surface of the connecting body 123.

Specifically, a size of each of the protruding rings 1133 gradually increases from a first end thereof away from the connecting body 113 to a second end thereof connected to the connecting body 1133. A size of each of the protruding rings 1233 gradually increases from a first end thereof away from the connecting body 123 to a second end thereof connected to the connecting body 123.

Optionally, a cross section of each of the protruding rings 1133 is arc-shaped. A cross section of each of the protruding rings 1233 is arc-shaped.

Furthermore, two first protruding structures 1131 and two second protruding structures 1132 are disposed on the outer surface of the connecting body 113, the two first protruding structures 1131 are close to the first connecting end 111, the two first protruding structures 1131 are oppositely disposed, the two second protruding structures 1132 are close to the second connecting end 112, and the two second protruding structures 1132 are oppositely disposed. Two first protruding structures 1231 and two second protruding structures 1232 are disposed on the outer surface of the connecting body 123, the two first protruding structures 1231 are close to the first connecting end 121, the two first protruding structures 1231 are oppositely disposed, the two second protruding structures 1232 are close to the second connecting end 122, and the two second protruding structures 1232 are oppositely disposed.

Optionally, a length of each of the first protruding structures 1131 along the length direction D1 of the mineral carriage stick 100 is greater than a length of each of the second protruding structures 1132 along the length direction D1 of the mineral carriage stick 100. A length of each of the first protruding structure 1231 along the length direction D1 of the mineral carriage stick 100 is greater than a length of each of the second protruding structures 1232 along the length direction D1 of the mineral carriage stick 100.

Optionally, a length L2 of the first connecting component 110 is greater than a length L1 of the second connecting component 120. It should be understood that the length L2 of the first connecting component 110 in the length direction D1 is greater than the length L1 of the second connecting component 120 in the length direction D1. In other alternative embodiments, the length of the first connecting component 110 is equal to the length of the second connecting component 120. In other alternative embodiments, the length of the first connecting component 110 is less than the length of the second connecting component 120. The length L2 of the first connecting component 110 and the length L1 of the second connecting component 120 are not specifically limited in the embodiment of the present disclosure, and the length of the first connecting component 110 and the length of the second connecting component 120 are determined according to actual requirements.

In the embodiment of the present disclosure, the first connecting end 111 and the first connecting end 121 are approximately the same in shape and approximately equal in size.

In the embodiment of the present disclosure, the second connecting end 112 and the second connecting end 122 are approximately the same in shape and approximately equal in size.

In order to further illustrate a size relationship between the first connecting component 110 and the second connecting component 120, the following embodiments describe exemplary descriptions with reference to other accompanying drawings.

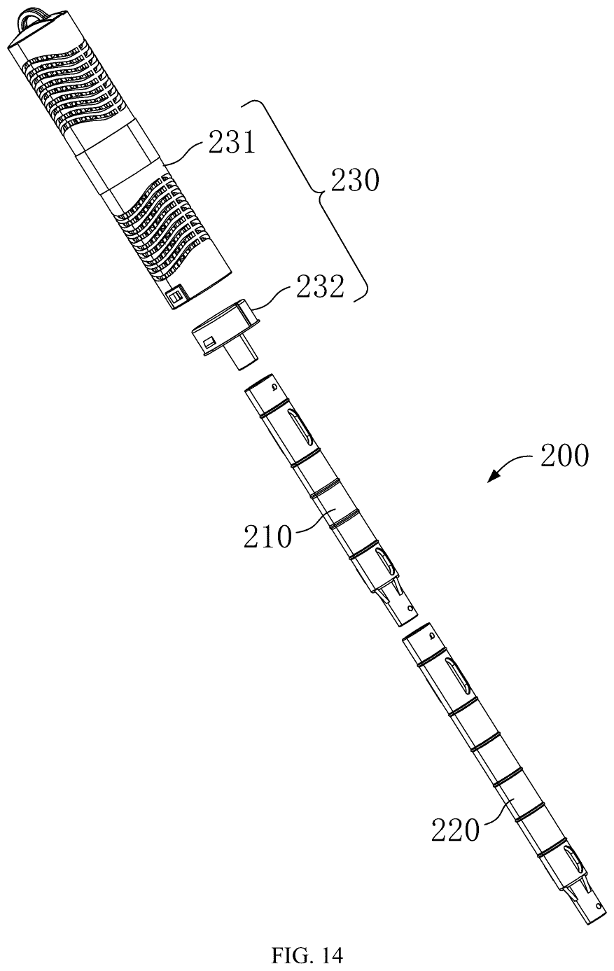

As shown in FIG. 14, in a second embodiment, the mineral carriage stick 200 includes a filter element 230, a first connecting component 210, and a second connecting component 220. A difference between the mineral carriage stick 200 and the filter element rod component 100 is that a length of the first connecting component 210 is less than a length of the second connecting component 220. A connection relationship between the first connecting component 210 and the second connecting component 220 may refer to the connection relationship between the first connecting component 110 and the second connecting component 120, and structures of a filter element housing 231 and a filter element cover 232 of the filter element 230 may refer to the filter element housing 131 and the filter element cover 132 of the filter element 130, and details are not repeatedly described herein.

In the embodiment, the first connecting component 210 may be equivalent to the second connecting component 120, and the second connecting component 220 is equivalent to the first connecting component 110, so that the connecting head of the filter element in the present disclosure is detachably connected to the first connecting end of one of the at least two connecting components, and the first connecting end of the other one of the at least two connecting components is detachably connected to the second connecting end of the other one of the at least two connecting components.

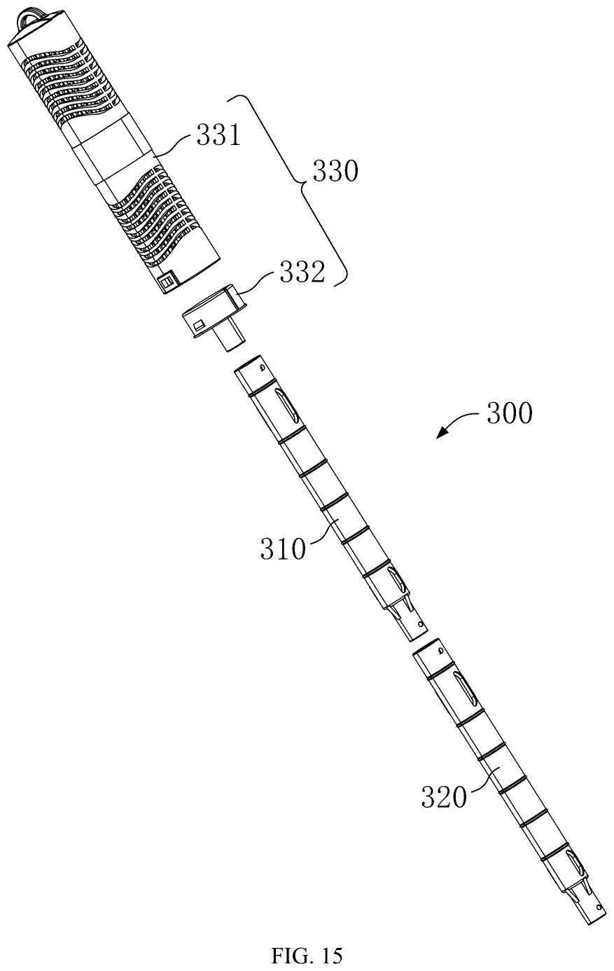

As shown in FIG. 15, in a third embodiment, the mineral carriage stick 300 includes a filter element 330, a first connecting component 310, and a second connecting component 320. A difference between the mineral carriage stick 300 and the filter element rod component 100 is that a length of the first connecting component 310 is equal to a length of the second connecting component 320. A connection relationship between the first connecting component 310 and the second connecting component 320 may refer to the connection relationship between the first connecting component 110 and the second connecting component 120, and structures of a filter element housing 331 and a filter element cover 332 of the filter element 330 may refer to the filter element housing 131 and the filter element cover 132 of the filter element 130, and details are not repeatedly described herein.

In the embodiment, the first connecting component 310 is equivalent to the second connecting component 320.

It should be noted that the mineral carriage stick 100, the mineral carriage stick 200, and the mineral carriage stick 300 may further include one or more third connecting components, and specific connection relationship between the connecting components may refer to the connection relationship between the first connecting component 110 and the second connecting component 120, and details are not repeatedly described herein.

It should also be noted that, in practical applications, the number of connecting components of the mineral carriage stick 100, the number of connecting components of the mineral carriage stick 200, and the number of connecting components of the mineral carriage stick 300 are determined according to actual requirements.

The above embodiments of the present disclosure provide a detailed illustration to the mineral carriage stick. In the present disclosure, specific embodiments are applied to illustrate the principles and implementations of the present disclosure. The above description of the embodiments is only used to better understand methods and core ideas of the present disclosure. Meanwhile, according to the ideas of the present disclosure, changes are made in the specific implementations and the application scope by those skilled in the art. Therefore, the contents of the specification should not be regarded as a limitation of the present disclosure.

What is claimed is:

1. A mineral cartridge stick, comprising:
a filter element, and
at least two connecting components;
wherein the filter element defines through holes and an accommodating space for accommodating filtering materials; the through holes are communicated with the accommodating space; the filter element comprises a connecting head;
wherein each of the connecting components comprises a connecting body, a first connecting end, and a second connecting end; the first connecting end thereof is connected to a first end of the connecting body thereof, and the second connecting end thereof is connected to a second end of the connecting body thereof; the at least two connecting components comprise a first connecting component and a second connecting component; the first connecting end of the first connecting component is detachably connected to the connecting head; the first connecting end of the second connecting component is detachably connected to the second connecting end of the first connecting component.

2. The mineral cartridge stick according to claim 1, wherein the first connecting end of the first connecting component is sleeved with the connecting head; or
the first connecting end of the first connecting component is screwed with the connecting head; or
the first connecting end of the first connecting component snapped with the connecting head; or
the first connecting end of the first connecting component is detachably connected to the connecting head through a first detachable component.

3. The mineral cartridge stick according to claim 1, wherein the first connecting end of the second connecting component is sleeved with the second connecting end of the first connecting component; or
the first connecting end of the second connecting component is screwed with the second connecting end of the first connecting component; or
the first connecting end of the second connecting component is snapped with the second connecting end of the first connecting component; or
the first connecting end of the second connecting component is detachably connected to the second connecting end of the first connecting component through a scone detachable component.

4. The mineral cartridge stick according to claim 1, wherein a length of the first connecting component is equal to a length of the second connecting component; or
the length of the first connecting component is greater than the length of the second connecting component; or
the length of the first connecting component is less than the length of the second connecting component.

5. The mineral cartridge stick according to claim 1, wherein the first connecting end of the second connecting component is sleeved on the second connecting end of the first connecting component; a protrusion is disposed on an outer surface of each second connecting end; a clamping hole is defined on each first connecting end; each protrusion is allowed to be clamped in a corresponding clamping hole and is allowed to be taken out of the corresponding clamping hole.

6. The mineral cartridge stick according to claim 5, wherein a sliding groove is defined on each first connecting end and is communicated with a corresponding clamping hole; each sliding groove is located on an inner surface of each first connecting end; each protrusion is slidable in a corresponding sliding groove; the protrusion of the first connecting component is clamped in the clamping hole of the second connecting component through the sliding groove of the second connecting component.

7. The mineral cartridge stick according to claim 5, wherein reinforcing ribs are connected between the second connecting end of each of the connecting components and the connecting body thereof; the reinforcing ribs of each of the connecting components are spaced apart from the protrusion thereof.

8. The mineral cartridge stick according to claim 7, wherein a thickness of each of the reinforcing ribs gradually increases from a first end thereof away from a corresponding connecting body to a second end thereof connected to the corresponding connecting body.

9. The mineral cartridge stick according to claim 1, wherein protruding rings spaced apart from each other are disposed on an outer surface of each connecting body; the protruding rings thereof are disposed around the outer surface of each connecting body.

10. The mineral cartridge stick according to claim 9, wherein a size of each of the protruding rings gradually increases from a first end of each of the protruding rings away from each connecting body to a second end of each of the protruding rings connected with each connecting body.

11. The mineral cartridge stick according to claim 9, wherein a cross-section of each of the protruding rings is arc-shaped.

12. The mineral cartridge stick according to claim 9, wherein two first protruding structures and two second protruding structures are disposed on the outer surface of each connecting body; the two first protruding structures of each of the connecting components are close to the first connecting end thereof; the two first protruding structures of each of the connecting components are disposed opposite to each other, the two second protruding structures of each of the connecting components are close to the second connecting end of each of the connecting components, and the two second protruding structures of each of the connecting components are disposed opposite to each other.

13. The mineral cartridge stick according to claim 12, wherein a length of each of the first protruding structures is greater than a length of each of the second protruding structures along a length direction of the mineral cartridge stick.

14. The mineral cartridge stick according to claim 1, wherein the mineral cartridge stick comprises a filter element housing and a filter element cover; the filter element housing is detachably connected to the filter element cover; the connecting head is disposed on the filter element cover; the through holes are defined on the filter element housing; the accommodating space is defined in the filter element housing.

15. The mineral cartridge stick according to claim 14, wherein a first end of the filter element housing defines an opening; the opening is communicated with the accommodating space; when the filter element cover is connected to the filter element housing, the filter element cover covers the opening.

16. The mineral cartridge stick according to claim 15, wherein the filter element cover further comprises a cover body; the connecting head is connected to the cover body, at least a part of the cover body is inserted into the accommodating space from the opening to cover the opening; the connecting head extends outside the filter element housing from the one end of the filter element housing.

17. The mineral cartridge stick according to claim 16, wherein the filter element housing is snapped with the filter element cover; at least one first limiting structure is disposed on an inner surface of the filter element housing; at least one second limiting structure is disposed on an edge of an outer surface of the cover body; the at least one first limiting structure is connected to the at least one second limiting structure to connect the filter element cover to the filter element housing, and the at least one first limiting structure is separated from the at least one second limiting structure to separate the filter element cover from the filter element housing.

18. A mineral cartridge stick, comprising: at least two connecting components;
wherein each of the connecting components comprises a connecting body, a first connecting end and a second connecting end, the first connecting end thereof is connected to a first end of the connecting body thereof, and the second connecting end thereof is connected to a second end of the connecting body thereof; the first connecting end of one of the connecting components is detachably connected to the second connecting end of the other one of the connecting components.
